(19) United States
(12) Patent Application Publication
(10) Pub. No.: US 2015/0145853 A1
(43) Pub. Date: May 28, 2015

(54) PIXEL CIRCUIT, METHOD FOR DRIVING THE SAME, ARRAY SUBSTRATE, DISPLAY DEVICE

(71) Applicant: Hefei Boe Optoelectronics Technology Co., Ltd, Hefei, Anhui (CN)

(72) Inventors: Mian Zeng, Beijing (CN); Yongjun Yoon, Beijing (CN); Zhizhong Tu, Beijing (CN); Jaikwang Kim, Beijing (CN)

(73) Assignee: Boe Technology Group Co., Ltd, Beijing (CN)

(21) Appl. No.: 14/344,666

(22) PCT Filed: May 4, 2013
(86) PCT No.: PCT/CN2013/075160

§ 371 Date: Mar. 13, 2014

(30) Foreign Application Priority Data
Mar. 20, 2013 (CN) 20130090818.2

(51) Int. Cl. G09G 3/32

(52) U.S. Cl. CPC G09G 3/3258; G09G 2320/045; G09G 2300/0876; G09G 2310/0251; G09G 2310/0278; G09G 2320/0204; G09G 2320/0233; G09G 2300/0819
USPC 345/215; 345/82

(57) ABSTRACT

A pixel circuit and method for driving the same, an array substrate, and a display device are provided, wherein the pixel circuit includes a driving transistor (DTFT), a first switching transistor (M1), a storage capacitor (C1) and a light emitting device and a threshold compensating circuit; the threshold compensating circuit includes a second switching transistor (M2), a third switching transistor (M3), a fourth switching transistor (M4) and a coupling capacitor (C2), which is capable of compensating for non-uniformity of threshold voltage of the driving transistor (DTFT) effectively. The method for driving the pixel circuit includes a pre-charging phase (C), a compensating phase (D) and a light emitting phase (E). The array substrate includes the above-described pixel circuit and thus has a more stable performance. The display device includes the above-described array substrate, and thus uniformity of picture displayed on the display device is improved significantly.

### TECHNICAL FIELD OF THE DISCLOSURE

The present disclosure relates to a field of organic light emitting display technology, and particularly to a pixel circuit and method for driving the same, an array substrate, and a display device.

### BACKGROUND

Compared to an existing Thin Film Transistor Liquid Crystal Display as a mainstream display technology, an organic light emitting diode (OLED) display has advantages of broader viewing angle, higher luminance, higher contrast, lower power consumption; thinner thickness and lighter weight and so on, and has currently become a focus of attention in a field of tablet display technology.

Methods for driving an organic light emitting display are divided into two types: a passive matrix (PM) type and an active matrix (AM) type. Compared to the passive matrix type driving method, the active matrix type driving method has advantages such as capability of displaying a huge amount of information lower power consumption, longer lifespan of devices, higher contrast of picture and so on. As shown in FIG. 1, an equivalent circuit of an existing pixel unit driving circuit in an active matrix type organic light emitting display includes a first switching transistor M1, a driving transistor M2, a storage capacitor C1 and a light emitting device D1; wherein a source of the first switching transistor M1 is connected to a gate of the driving transistor M2; the gate of the driving transistor M2 is connected to one terminal of the storage capacitor C1, a drain of the driving transistor M2 is connected to the other terminal of the storage capacitor C1, and a source of the driving transistor M2 is connected to a light emitting device D1. The first switching transistor M1 is turned on when the gate thereof is activated by a scan signal Vscan(n). and is imported a data signal Vdata from the drain thereof. The driving transistor M2 usually operates in a saturation region, wherein a current flowing through the driving transistor M2 depends on a gate-source voltage Vgs of the driving transistor M2, such that a stable current may be provided for the light emitting device D1. Vgs=Vdata−VD1, VD1 is a turn-on voltage of the light emitting device D1, VDD is a voltage-stabilized power supply or a current-stabilized power supply and is connected to the driving transistor M2 so as to supply the power required for the light emitting device D1 to emit light. The storage capacitor C1 functions to maintain a voltage at the gate of the driving transistor M2 stable during a frame period.

When a first high level of the scan signal Vscan(n) arrives, an n^{th} row of pixel units is activated, the first switching transistor M1 in each pixel unit of the row of pixel units is turned on and imports the data signal Vdata for driving the light emitting device D1 to emit light. The light emitting device D1 emits light under the control of a high level of the data signal Vdata. After charging of the storage capacitor C1 in each pixel unit of the row of pixel units is completed, the first switching transistor M1 in each pixel unit of the row of pixel units is then turned off by a first low level of the scan signal Vscan(n). At this time, the storage capacitor C1 maintains its voltage as charged and ensures that the driving transistor M2 in each pixel unit of the row of pixel units to output a stable current, such that the organic light emitting diode D1 in each pixel unit of the row of pixel units emits light continuously until the end of the frame period. The frame period is usually a time interval between two adjacent activations of a same row of pixel units by the scan signal.

After the charging of the n^{th} row of pixel units is completed, an (n+1)^{th} row of pixel units is activated by a scan signal, the first switching transistor M1 in each pixel unit of the (n+1)^{th} row of pixel units is turned on, imports the data signal Vdata to perform a same charging process. After the charging is completed, the storage capacitor C1 maintains its voltage as charged and ensures that the driving transistor to output a stable current, such that the organic light emitting diode D1 in each pixel unit of the (n+1)^{th} row of pixel units emits light continuously until the end of the frame period. The above operations are repeated for each row of pixel units, after the charging of a last row of pixel units is completed, scanning and charging will be restarted from a first row of pixel units.

Though the pixel unit circuit in the prior art are used widely, it has the following inevitable problems: the threshold voltage Vth of the driving transistor M2 will drift with the increasing of operating time of the driving transistor M2, such that the Vgs corresponding to a same data signal Vdata varies, that is, the current (i.e. luminance) of the light emitting device D1 varies, and thus uniformity of picture displayed on a whole organic light emitting display and light emitting quality thereof will be affected.

### SUMMARY

Technical problems to be solved in embodiments of the present disclosure include instability of an existing pixel unit circuit caused by drifts of threshold voltages of driving transistors among different pixel units of the existing pixel unit circuit, which may render poor uniformity of picture display on an organic light emitting display and poor light emitting performance of the organic light emitting display. In the embodiments of the present disclosure, there is provided a pixel circuit and method for driving the same, an array substrate, and a display device capable of effectively compensate for the non-uniformity of the threshold voltages of the driving transistors so as to improve the uniformity of the picture displayed on the organic light emitting display.

According to the embodiments of the present disclosure, there is provided a pixel circuit including a driving transistor, a first switching transistor, a storage capacitor, a light emitting device and a threshold compensating circuit; wherein the threshold compensating circuit includes a second switching transistor, a third switching transistor, a fourth switching transistor and a coupling capacitor;

a gate of the first switching transistor is configured to receive a first scan signal, a second electrode of the first switching transistor is connected to a data signal input terminal, and a third electrode of the first switching transistor is connected to a first terminal of the storage capacitor, a first terminal of the coupling capacitor and a second electrode of the second switching transistor;

a second terminal of the storage capacitor is configured to receive a power supply voltage and is connected to a second electrode of the driving transistor;

a gate of the second switching transistor is configured to receive a second scan signal and is connected to a gate of the third switching transistor, and a third electrode of the second switching transistor is connected to a negative terminal of a power supply;

a second electrode of the third switching transistor is connected to a gate of the driving transistor, and a third electrode of the third switching transistor is connected to a third electrode of the driving transistor and a second electrode of the fourth switching transistor;

a gate of the fourth switching transistor is configured to receive a first control signal, and a third electrode of the fourth switching transistor is connected to the light emitting device;

a second terminal of the coupling capacitor is connected to the gate of the driving transistor.

In the pixel circuit of the present disclosure, the threshold compensating circuit including the second switching transistor, the third switching transistor, the fourth switching transistor and the coupling capacitor is included, so as to compensate for drift of the threshold voltage of the driving transistor, thus effectively compensating for the non-uniformity of the threshold voltages of the driving transistors and improving the uniformity of the picture displayed on the organic light emitting display.

Optionally, the first switching transistor, the second switching transistor, the third switching transistor, the fourth switching transistor and the driving transistor are N type thin film transistors, wherein the second electrodes are drains and the third electrodes are sources.

Optionally, the first, switching transistor, the second switching transistor, the third switching transistor, the fourth switching transistor and the driving transistor are P type thin film transistors, wherein the second electrodes are sources and the third electrodes are drains.

Optionally, the light emitting device is an organic light emitting diode.

According to the embodiments of the present disclosure, there is a method for driving the pixel circuit described above including steps of:

during a pre-charging phase, activating the second scan signal and the power supply voltage so as to turn on the second switching transistor and the third switching transistor, such that electronic charges stored in the coupling capacitor are released;

during a compensating phase, activating the first scan signal so as to turn on the first switching transistor, and deactivating the second scan signal, such that the data signal is input to the first terminal of the coupling capacitor and the first terminal of the storage capacitor, and the voltage at the second terminal of the coupling capacitor is raised and the driving thin film transistor is turned on;

during a light emitting phase, activating the control signal so as to turn on the fourth switching transistor, such that the storage capacitor maintains the voltage at the first terminal of the coupling capacitor, and the driving transistor continues to be maintained in turn-on state and drives the light emitting device to emit light.

The method for driving the pixel circuit has a simple timing sequence and can be implemented easily for control.

According to an embodiment of the present disclosure, there is provided an array substrate including the above described pixel circuit.

The array substrate of the present disclosure operates stably since it includes the above described pixel circuit.

According to an embodiment of the present disclosure, there is provided an display device including the above described array substrate.

The picture displayed by the display device of the present disclosure shows a high uniformity since the display device includes the above described array substrate.

### BRIEF DESCRIPTION OF THE DRAWINGS

FIG. 1 is a principle diagram of an existing pixel circuit;

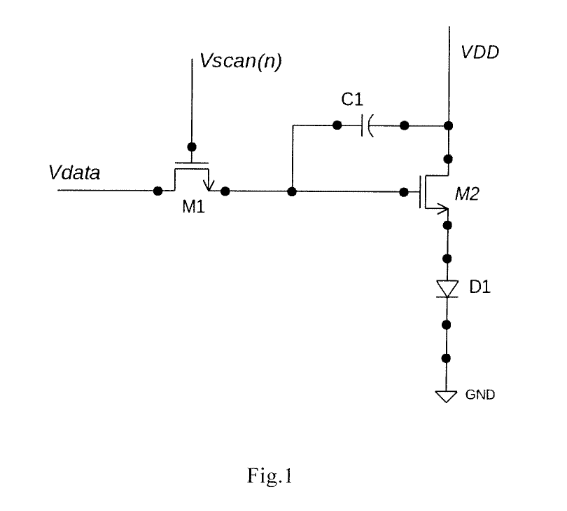

FIG. 2 is a circuit diagram of a pixel circuit according to embodiments of the present disclosure; and

FIG. 3 is a timing diagram of the pixel circuit in FIG. 2.

Reference signs: M1—first switching transistor; DTFT—driving transistor; M2—second switching transistor; M3—third switching transistor, M4—fourth switching transistor; C1—storage capacitor; C2—coupling capacitor; D1—light emitting diode; Vdata—data signal; Vscan(n)—first scan signal; Vscan(n−1)—second scan signal; EM—first control line.

### DETAILED DESCRIPTION

For the purpose of the technical solutions of the present disclosure being well understood by those skilled in the art, the present disclosure will be described in detail in combination with accompanying drawings and particular implementations of the present disclosure below.

### First Embodiment

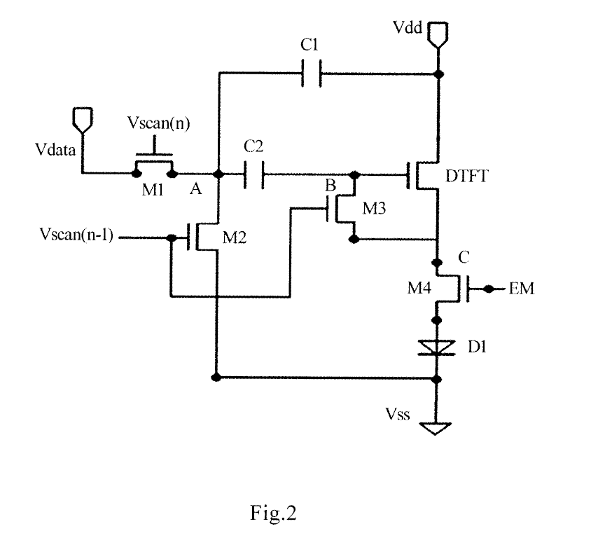

In the present embodiment, there is provided a pixel circuit as shown in FIG. 2, wherein the pixel circuit comprises a driving transistor DTFE a first switching transistor M1, a storage capacitor C1, a light emitting device and a threshold compensating circuit; wherein the threshold compensating circuit includes a second switching transistor M2, a third switching transistor M3, a fourth switching transistor M4 and a coupling capacitor C2;

a gate of the first switching transistor M1 is configured to receive a first scan signal Vscan(n), a drain of the first switching transistor M1 is connected to a data signal input terminal Vdata. and a source of the first switching transistor M1 is connected to a first terminal of the storage capacitor C1, a first terminal of the coupling capacitor C2 and a drain of the second switching transistor M2;

a second terminal of the storage capacitor C1 is configured to receive a power supply voltage Vdd and is connected to a drain of the driving transistor DTFT;

a gate of the second switching transistor M2 is configured to receive a second scan signal Vscan(n−1) and is connected to a gate of the third switching transistor M3, and a source of the second switching transistor M2 is connected to a negative terminal of a power supply Vss;

a drain of the third switching transistor M3 is connected to a gate of the driving transistor DTFT and a source of the third switching transistor M3 is connected to a source of the driving transistor DTFT and further to a drain of the fourth switching transistor M4;

a gate of the fourth switching transistor M4 is configured to receive a first control signal EM, and a source of the fourth switching transistor M4 is connected to the light emitting device D1;

a second terminal of the coupling capacitor C2 is connected to the gate of the driving transistor DTFT.

Particularly, the light emitting device D1 is an organic light emitting diode, the first switching transistor M1, the second switching transistor M2, the third switching transistor M3, the fourth switching transistor M4 and the driving transistor DTFT are N type thin film transistors; optionally, all of the switching transistors merely function as switches, and may also he P type transistors as long as signals for turning on or off the switching transistors are adjusted accordingly. Since sources and drains of the switching transistors adopted herein are symmetric in structure, and thus may be interchanged to each other. In the embodiments of the present disclosure, in order to distinguish two electrodes other than a gate of a transistor, one is referred to as a source and the other is referred to as a drain. The drain may be used as a signal output terminal when the source is used as a signal input terminal, and vice versa.

Below, the operational process of the pixel circuit will be described in detail,

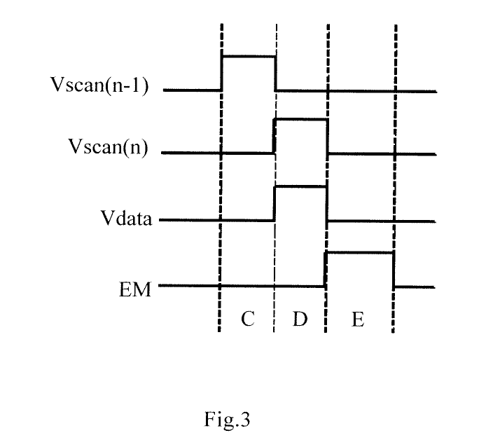

combining the pixel circuit shown in FIG. 2 with the timing diagram shown in FIG. 3, the operational process can be divided into three phases: a pre-charging phase, a compensating phase and light emitting phase.

A first phase is the pre-charging phase C, when an (n−1)^{th} row of pixel units is

activated by the scan signal, the second scan signal Vscan(n−1) corresponding to the (n−1)^{th} row of pixel units is at a high level the second switching transistor M2 and the third switching transistor M3 are maintained on; meanwhile the first scan signal Vscan(n) corresponding to an row of pixel units is at a low level, the first switching transistor M1 is turned off, the first control signal EM is at a low level, the fourth switching transistor M4 is also maintained off. At this time, both a voltage of a point A at the drain of the second switching transistor M2 and a voltage of a point B at the gate of the driving transistor DTFT begin to decrease and electronic charges stored in the coupling capacitor C2 are released, and a voltage across the coupling capacitor C2 is decreased to the threshold voltage Vth of the driving transistor DTFT the voltage of the point A is decreased to 0 and the voltage of the point B is decreased to the threshold voltage Vth of the driving transistor DTFT, such that the driving transistor DTFT is turned off and the voltage across the coupling capacitor C2 is changed to a voltage difference Vth between the voltage of the point A and the voltage of the point B.

A second phase is the compensating phase D, wherein when the n^{th} row of pixel units is activated by the scan signal, the second scan signal Vscan(n−1) corresponding to the (n−1)^{th} row of pixel units is at a low level, the second switching transistor M2 and the third switching transistor M3 are turned off; meanwhile the first scan signal Vscan(n) corresponding to the n^{th} row of pixel units is at a high level, the first switching transistor M1 is turned on, such that the data signal Vdata on the data fine is imported, and the storage capacitor C1 is charged to storage the data signal Vdata. Then, the voltage of the point A is raised to Vdata by the data signal Vdata, and the voltage of the point B at the gate of the driving transistor DTFT is raised to Vdata+Vth due to the bootstrapping effect of the coupling capacitor C2, thus the driving transistor is maintained in a critical turn-on state.

A third phase is the light emitting phase B, the first control signal EM is at a high level to control the fourth switching transistor M4 to be turned on; the driving transistor DTFT is turned on since the power supply voltage Vdd is much larger than the data voltage Vdata, and a current is supplied by the power supply voltage Vdd via the driving transistor DTFT to the light emitting device D1 so as to drive the light emitting device D1 to emit light.

At this time, the current flowing through the driving transistor DTFT may be represented by:

I=k(Vgs−Vth)² (1)

wherein k is a constant and k=½*μ*Cox*W/L.

The gate-source voltage of the driving transistor DTFT is Vgs=Vg−Vs. The voltage at the gate of the driving transistor DTFT Vg is the voltage of the point B Vdata+Vth, and the voltage at the source of the driving transistor DTFT Vs is a voltage of a point C at this time, that is, a turn-on voltage V_{D1} of the light emitting device D1. Therefore, the gate-source voltage of the driving transistor DTFT is:

Vgs=Vdata+Vth−V_{D1} (2)

By substituting the above equation (2) into the equation (1), we can obtain:

I=k(Vgs−Vth)²=k(Vdata+Vth−V_{D1}−Vth)²=k(Vdata−V_{D1})² (3)

It can be seen from the equation (3) that the value of the current flowing through the driving transistor DTFT has no relation to the variation of the threshold voltage of the driving transistor DTFT, that is to say, after a long term usage of the driving transistor DTFT, the current flowing through the driving transistor DTFT will not be affected even if the threshold voltage of the driving transistor DTFT drifts, thus ensuring the quality of the light-emitting of the light-emitting device OLED. Accordingly, the pixel circuit of the embodiments of the present disclosure may compensate for the non-uniformity of the threshold voltages of the driving transistors since the light emitting performance of the light emitting device D1 in each pixel circuit can be ensured, such that the uniformity of picture displayed by the display device may be improved. In addition, no external compensating circuit is needed to compensate the threshold voltage, so researching and manufacturing cost will be reduced. Moreover, the timing sequence of the pixel circuit is simple and is thus easy to be implemented.

Optionally, the first switching transistor, the second switching transistor, the third switching transistor, the fourth switching transistor and the driving transistor are N type thin film transistors.

Optionally, the light emitting device is an organic light emitting diode. Of course, other light emitting devices may also be adopted,

### Second Embodiment

In the present embodiment, there is provided a method for driving the above described pixel circuit, the method includes steps of:

During a pre-charging phase, activating the second scan signal Vscan(n−1) and the power supply voltage Vdd so as to turn on the second switching transistor M2 and the third switching transistor M3, such that electronic charges stored in the coupling capacitor C2 are released to an extent that the voltage at the second terminal of the coupling capacitor C2 is equal to the threshold voltage of the driving transistor DTFT;

during a compensating phase, activating the first scan signal Vscan(n) so as to turn on the first switching transistor M1, and deactivating the second scan signal Vscan(n−1), such that the data signal Vdata is input to the first terminal of the coupling capacitor C2, and the voltage at the second terminal of the coupling capacitor C2 is raised, so that the driving thin film transistor DTFT is turned on;

during a light emitting phase, activating the first control signal EM so as to turn on the fourth switching transistor M4, such that the driving transistor DTFT continues to be maintained in turn-on state and drives the light emitting device D1 to emit light.

Particular implementations of the method are same us those in the operational process in the first embodiment details omitted. The method may be applied widely since it is simple and easy to be implemented.

### Third Embodiment

In the present embodiment, there is provided an array substrate including a plurality of data lines and a plurality of scan lines, wherein the data lines and the scan lines are intersected, and the pixel circuit of the first embodiment is arranged at each intersection.

In the present embodiment, the threshold compensating circuit in the pixel circuit of the first embodiment is included, which can effectively compensate for the non-uniformity of the threshold voltages of the driving transistors DTFT, so that the array substrate of the present embodiment may have a more stable performance.

### Fourth Embodiment

In the present embodiment, there is provided a display device, and an array substrate of an organic light emitting display device in the display device is the array substrate as described in the third embodiment, details omitted.

The display device of the present embodiment may be any product or mean with a display function, such as, an OLED panel, a mobile phone, a tablet computer, a television, a display, a notebook computer, a digital photo frame, a navigator and so on.

The uniformity of picture displayed on the display device of the present embodiment is improved significantly, since the display device of the present embodiment includes the above described array substrate of the display device.

It should be understood that the above descriptions are only for illustrating the embodiments of the present disclosure, and will make no limitation to the present disclosure, Those skilled in the art may make modifications, variations, equivalences and improvements to the above embodiments without departing from the spirit and essential of the present disclosure. These modifications, variations, equivalences and improvements are intended to he included in the protection scope of the present disclosure.

1. A pixel circuit comprising a first switching transistor, a storage capacitor, a driving transistor, a light emitting device and a threshold compensating circuit; wherein
the threshold compensating circuit comprises a second switching transistor, a third switching transistor, a fourth switching transistor and a coupling capacitor;
a gate of the first switching transistor is configured to receive a first scan signal, a second electrode of the first switching transistor is connected to a data signal input terminal, and a third electrode of the first switching transistor is connected to a first terminal of the storage capacitor, a first terminal of the coupling capacitor and a second electrode of the second switching transistor;
a second terminal of the storage capacitor is configured to receive a power supply voltage and is connected to a second electrode of the driving transistor;
a gate of the second switching transistor is configured to receive a second scan signal and is connected to a gate of the third switching transistor, and a third electrode of the second switching transistor is connected to a negative terminal of a power supply;
a second electrode of the third switching transistor is connected to a gate of the driving transistor, and a third electrode of the third switching transistor is connected to a third electrode of the driving transistor and a second electrode of the fourth switching transistor;
a gate of the fourth switching transistor is configured to receive a first control signal, and a third electrode of the fourth switching transistor is connected to the light emitting device; and
a second terminal of the coupling capacitor is connected to the gate of the driving transistor.

2. The pixel circuit of claim 1, wherein the first switching transistor, the second switching transistor, the third switching transistor, the fourth switching transistor and the driving transistor are N type thin film transistors, wherein the second electrodes are drains and the third electrodes are sources.

3. The pixel circuit of claim 1, wherein the first switching transistor, the second switching transistor, the third switching transistor, the fourth switching transistor and the driving transistor are P type thin film transistors, wherein the second electrodes are sources and the third electrodes are drains.

4. The pixel circuit of claim 1, wherein the light emitting device is an organic light emitting diode.

5. A method for driving the pixel circuit of claim 1 comprising:
a pre-charging phase, in which the second scan signal and the power supply voltage are activated and the second switching transistor and the third switching transistor are both turned on, such that electronic charges stored in the coupling capacitor are released through the second switching transistor;
a compensating phase, in which the first scan signal is activated and the first switching transistor is turned on, and the second scan signal is deactivated, such that the data signal is input to the first terminal of the coupling capacitor and the first terminal of the storage capacitor, and the voltage at the second terminal of the coupling capacitor is raised to turn on the driving thin film transistor;
a light emitting phase, the first control signal is activated and the fourth switching transistor is turned on, the storage capacitor maintains the voltage at the first terminal of the coupling capacitor, and the driving transistor continues to be maintained in a turn-on state and drives the light emitting device to emit light.

6. An array substrate comprising the pixel circuit of claim 1.

7. (canceled)

8. The array substrate of claim 6, wherein the first switching transistor, the second switching transistor, the third switching transistor, the fourth switching transistor and the driving transistor are N type thin film transistors, wherein the second electrodes are drains and the third electrodes are sources.

9. The array substrate of claim 6, wherein the first switching transistor, the second switching transistor, the third switching transistor, the fourth switching transistor and the driving transistor are P type thin film transistors, wherein the second electrodes are sources and the third electrodes are drains.

10. The array substrate of claim 6, wherein the light emitting device is an organic light emitting diode.
